(19) United States
(12) Patent Application Publication
(10) Pub. No.: US 2014/0042800 A1
(43) Pub. Date: Feb. 13, 2014

(54) BRAKE SYSTEM AND METHOD OF CONTROLLING THE SAME

(71) Applicant: Samsung Techwin Co., Ltd., Changwon-city (KR)

(72) Inventor: Won-Seo KIM, Changwon-city (KR)

(21) Appl. No.: 13/962,300

(22) Filed: Aug. 8, 2013

(30) Foreign Application Priority Data
Aug. 10, 2012 (KR) 10-2012-0087991
Jun. 14, 2013 (KR) 10-2013-0068642

(51) Int. Cl. B60T 13/58; B60T 13/24

(52) U.S. Cl. CPC B60T 13/586; B60T 13/24
USPC 303/3

(57) ABSTRACT

There is provided a brake system for performing regenerative braking and friction braking to brake a rotating body, the brake system including: a manipulation part configured to provide a brake input; a regenerative braking unit configured to perform regenerative braking; a friction braking unit configured to perform friction braking; and a control unit configured to control the brake system, wherein the friction braking unit includes: a friction working part configured to brake a rotating body by friction; a pneumatic line system configured to operate the friction working part; a first valve part connected to the pneumatic line system; and a second valve part connected to the pneumatic line system and connected in parallel to the first valve part.

### CROSS-REFERENCE TO RELATED PATENT APPLICATIONS

This application claims priority from Korean Patent Application No. 10-2012-0087991, filed on Aug. 10, 2012, and Korean Patent Application No. 10-2013-0068642, filed on Jun. 14, 2013, in the Korean Intellectual Property Office, the disclosures of which are incorporated herein in their entireties by reference.

### BACKGROUND

1. Field

The present invention relates to a brake system and a method of controlling the same.

2. Description of the Related Art

Transportation devices using an electric motor as a power source have been considerably investigated. For example, much research has been conducted in relation to electric railway vehicles, electric vehicles, hybrid vehicles, golf carts, two-wheeled vehicles, electric bicycles, and the like and related businesses.

Generally, a transportation device using an electric motor as a power source includes a regenerative brake system.

A regenerative brake system is usually used with a hydraulic brake system. Korea Patent Publication No. 2011-0139836 discloses a technique of compensating for a hydraulic brake amount and a regenerative brake amount by estimating a frictional coefficient of a friction material according to a driving state of a vehicle.

### SUMMARY

One or more exemplary embodiments provide a brake system with stable brake performance and a method of controlling the same.

According to an aspect of an exemplary embodiment, there is provided a brake system for performing regenerative braking and friction braking to brake a rotating body, the brake system including: a manipulation part for providing a brake input; a regenerative braking unit for performing the regenerative braking; a friction braking unit for performing the friction braking; and a control unit for controlling the brake system, wherein the friction braking unit includes: a friction working part for braking the rotating body by friction; a pneumatic line system for operating the friction working part; a first valve part connected to the pneumatic line system; and a second valve part connected to the pneumatic line system and connected in parallel to the first valve part.

The manipulation part may include: a pedal; and a valve opening/closing part connected to the pedal to open or close the first valve part.

The brake system may further include a pedal sensor for measuring a motion of the pedal.

The regenerative braking unit may include: a power generation unit for converting a rotational motion of the rotating body into electric energy; and a battery unit charged by receiving electricity from the power generation unit.

The brake system may further include a charge amount measuring device for measuring a charge level of the battery unit.

The pneumatic line system may include: at least one storage tank for storing compressed air; and pneumatic lines connected to the storage tank.

The pneumatic line system may be connected to a hydraulic power assistance part which provides a braking force to the friction working part.

The brake system may further include a third valve part connected in series to the second valve part.

The brake system may further include: a bypass pipeline which bypasses the third valve part; and an emergency valve installed on the bypass pipeline.

According to an aspect of another exemplary embodiment, there is provided a method of controlling a brake system which performs regenerative braking and friction braking to brake a rotating body and includes a first valve part connected to a pneumatic line system for the friction braking and a second valve part connected in parallel to the first valve part, the method including: operating a manipulation part; opening the first valve part in response to the operation of the manipulation part; and determining whether the regenerative braking works in response to the operation of the manipulation part and opening the second valve part if the regenerative braking does not work.

The regenerative braking may include: a power generating operation of converting a rotational motion of the rotation body into electric energy; and a charging operation of charging a battery unit with electricity generated in the power generating operation.

The determining of whether the regenerative braking works may include determining whether the regenerative braking works by measuring a charge level of the battery unit in the charging operation.

According to an aspect of still another exemplary embodiment, there is provided a method of controlling a brake system which performs regenerative braking and friction braking to brake a rotating body and includes a first valve part connected to a pneumatic line system for the friction braking and a second valve part connected in parallel to the first valve part, the method including: operating a manipulation part; determining whether the regenerative braking works in response to the operation of the manipulation part and opening the second valve part if the regenerative braking does not work; and opening the first valve part if an operation level of the manipulation part exceeds a predetermined state.

The operation of the manipulation part may be performed by pressing a pedal, and if a stroke amount of the pedal exceeds a predetermined magnitude, it may be considered that an operation level of the manipulation part exceeds the predetermined state, and the first valve part may be open.

The regenerative braking may include: a power generating operation of converting a rotational motion of the rotating body into electric energy; and a charging operation of charging a battery unit with electricity generated in the power generating operation.

The determining of whether the regenerative braking works may include determining whether the regenerative braking works by measuring a charge level of the battery unit in the charging operation.

According to an aspect of still another exemplary embodiment, there is provided a method of controlling a brake system which performs regenerative braking and friction braking to brake a rotating body and includes a first valve part connected to a pneumatic line system for the friction braking, a second valve part connected in parallel to the first valve part, and a third valve part connected in series to the second valve part, the method including: operating a manipulation part; opening the first and second valve parts in response to the operation of the manipulation part; and determining whether the regenerative braking works in response to the operation of the manipulation part and opening the third valve part if the regenerative braking does not work.

The regenerative braking may include: a power generating operation of converting a rotational motion of the rotating body into electric energy; and a charging operation of charging a battery unit with electricity generated in the power generating operation.

The determining of whether the regenerative braking works may include determining whether the regenerative braking works by measuring a charge level of the battery unit in the charging operation.

### BRIEF DESCRIPTION OF THE DRAWINGS

The above and other aspects will become more apparent by describing in detail exemplary embodiments with reference to the attached drawings, in which:

FIG. 1 is a schematic diagram of a brake system according to a first exemplary embodiment;

FIG. 2 is a flowchart illustrating a method of controlling the brake system, according to the first exemplary embodiment;

FIGS. 3A to 3C are schematic operational diagrams of the method of controlling the brake system, according to the first exemplary embodiment;

FIG. 4 is a flowchart illustrating a method of controlling a brake system, according to a modified version of the first exemplary embodiment;

FIGS. 5A to 5D are schematic operational diagrams of the method of controlling the brake system, according to the modified version of the first exemplary embodiment;

FIG. 6 is a schematic diagram of a brake system according to a second exemplary embodiment;

FIG. 7 is a flowchart illustrating a method of controlling the brake system, according to the second exemplary embodiment;

FIGS. 8A to 8C are schematic operational diagrams of the method of controlling the brake system, according to the second exemplary embodiment; and

FIG. 9 is a schematic operational diagram of a case of opening an emergency valve in an emergency state where a third valve part of the brake system according to the second exemplary embodiment does not operate normally, according to an exemplary embodiment.

### DETAILED DESCRIPTION

The inventive concept will now be described more fully with reference to the accompanying drawings, in which exemplary embodiments thereof are shown. In addition, in the specification and the drawings, like reference numerals denote like elements having substantially the same configuration, and thus, only one description will be provided.

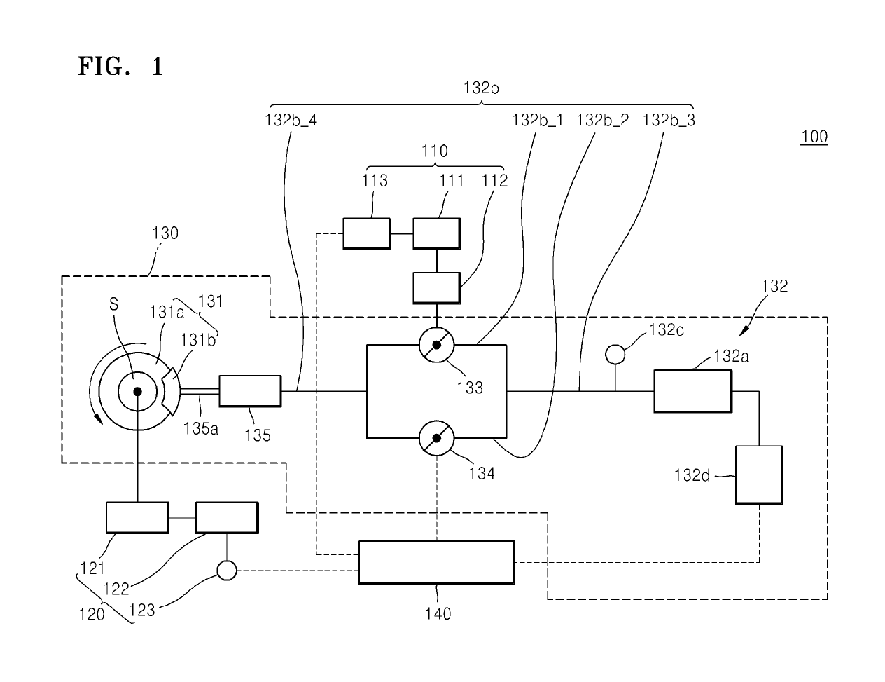

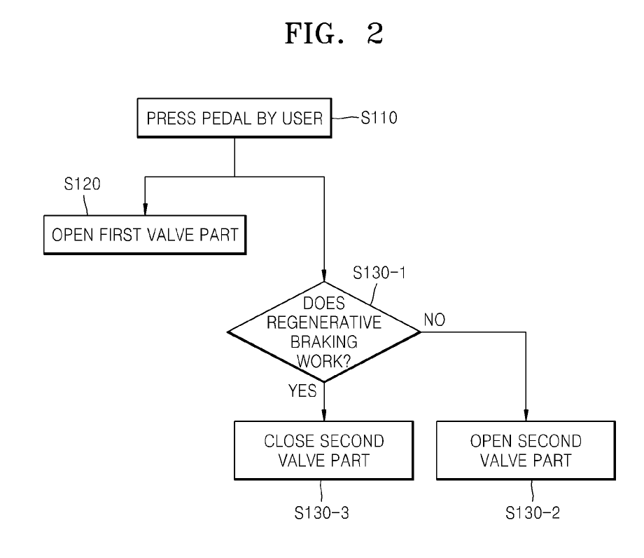

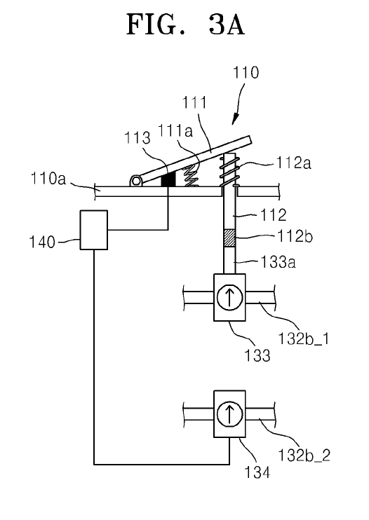

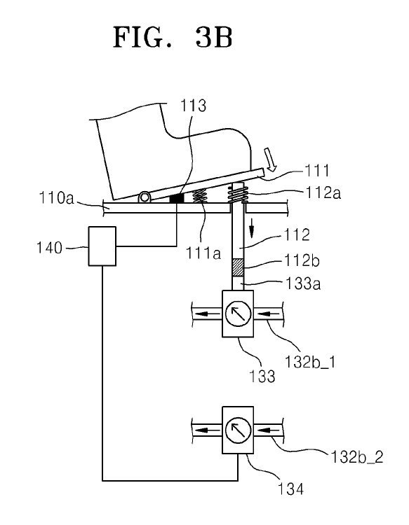

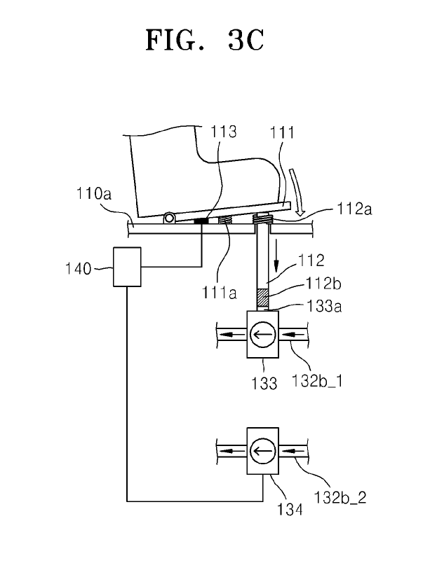

FIG. 1 is a schematic diagram of a brake system 100 according to a first exemplary embodiment. FIG. 2 is a flowchart illustrating a method of controlling the brake system 100, according to the first exemplary embodiment, and FIGS. 3A to 3C are schematic operational diagrams of the method of controlling the brake system 100, according to the first exemplary embodiment.

The brake system 100 according to the first exemplary embodiment includes a manipulation part 110, a regenerative braking unit 120, a friction braking unit 130, and a control unit 140.

The manipulation part 110 includes a pedal 111, a valve opening/closing part 112, and a pedal sensor 113.

A basic configuration of the manipulation part 110 is shown in FIG. 3A. That is, as shown in FIG. 3A, the pedal 111 is installed on a frame 110a in a hinge structure to pivot when a user presses the pedal 111 by foot and is elastically supported by a first elastic member 111a, such as a spring or the like.

The valve opening/closing part 112 has a bar shape and is elastically supported by a second elastic member 112a, such as a spring or the like, with respect to the frame 110a. In addition, a connection part 112b of the valve opening/closing part 112 is fixedly connected to an operation part 133a of a first valve part 133.

When the user presses the pedal 111, the valve opening/closing part 112 moves downwards by the pedal 111, and accordingly, the operation part 133a of the first valve part 133 also moves downwards, thereby opening the first valve part 133.

When the user releases the pressing, the pedal 111 returns to its original position by the first elastic member 111a, and the operation part 133a of the first valve part 133 also moves upwards by the second elastic member 112a, thereby closing the first valve part 133.

According to the first exemplary embodiment, the pedal 111, the valve opening/closing part 112, and the first valve part 133 are mechanically connected to each other and are configured to open the first valve part 133 by delivering a mechanical force for pressing the pedal 111 to the first valve part 133 via the valve opening/closing part 112, but the inventive concept is not limited thereto. That is, the valve opening/closing part 112 may be electronically configured and electrically connected to the pedal 111 to open or close the first valve part 133 by pressing the pedal 111.

The pedal sensor 113 measures a motion of the pedal 111 and includes a pedal effort sensor for measuring a load by using a load cell or the like. The pedal sensor 113 is electrically connected to the control unit 140, and the control unit 140 may determine whether the pedal 111 is pressed and a pressing stroke amount of the pedal 111 by using a measured load value.

According to the first exemplary embodiment, a pedal effort sensor is used as the pedal sensor 113, but the inventive concept is not limited thereto. That is, the pedal sensor 113 may include a rotation angle measuring sensor for measuring a rotation angle of the pedal 111, a distance sensor for measuring a movement amount of the pedal 111, and the like.

According to the first exemplary embodiment, the manipulation part 110 is configured to include the pedal 111 pressed by foot, but the inventive concept is not limited thereto. That is, a structure and a method for configuring the manipulation part 110 are not specially limited. For example, the manipulation part 110 may be a lever that may be pulled by hand.

The regenerative braking unit 120 brakes a rotational motion of a rotating body S according to a regenerative braking scheme and includes a power generation unit 121, a battery unit 122, and a charge amount measuring device 123.

The power generation unit 121 includes at least one power generator and converts a rotational motion of the rotating body S to electric energy. The number of power generators included in the power generation unit 121 is not specially limited.

The battery unit 122 includes at least one battery charged by receiving power from the power generation unit 121. The number of batteries included in the power generation unit 121 is not specially limited. For example, only one battery may be used or two or more of batteries may be used, and the batteries may be connected in series or parallel to each other.

The charge amount measuring device 123 measures a charge level of the battery unit 122, and a well-known charge sensor, a well-known charge amount measuring circuit, or a well-known circuit for measuring an internal voltage of the battery unit 122 may be used as the charge amount measuring device 123.

The charge amount measuring device 123 is electrically connected to the control unit 140, and thus, the control unit 140 may measure a charge level of the battery unit 122 by using a value transmitted from the charge amount measuring device 123.

The friction braking unit 130 brakes a rotational motion of the rotating body S according to a friction braking scheme.

The friction braking unit 130 includes a friction working part 131, a pneumatic line system 132, a first valve part 133, a second valve part 134, and a hydraulic power assistance part 135.

The friction working part 131 includes a brake wheel 131a rotating together with the rotating body S and a friction block 131b for braking a rotational motion of the rotating body S by rubbing against the brake wheel 131a.

The pneumatic line system 132 includes at least one storage tank 132a for storing compressed air, a pneumatic line 132b connected to the storage tank 132a, a pneumatic pressure sensor 132c for measuring a pneumatic pressure of the pneumatic line 132b, and an air compressor 132d.

The pneumatic line 132b includes a first pneumatic line 132b_1, a second pneumatic line 132b_2, a third pneumatic line 132b_3, and a fourth pneumatic line 132b_4.

The first valve part 133 is installed on the first pneumatic line 132b_1.

The second pneumatic line 132b_2 is connected in parallel to the first pneumatic line 132b_1, and the second valve part 134 is installed on the second pneumatic line 132b_2.

The third pneumatic line 132b_3 is connected to the storage tank 132a, and the fourth pneumatic line 132b_4 is connected to the hydraulic power assistance part 135.

The pneumatic pressure sensor 132c is electrically connected to the control unit 140 and transmits a measured pneumatic pressure to the control unit 140 in real-time. If the measured pneumatic pressure is less than a reference value, the control unit 140 drives the air compressor 132d to supply compressed air to the storage tank 132a so that a pneumatic pressure within a predetermined range is maintained in the pneumatic line 132b.

The first valve part 133 is installed on the first pneumatic line 132b_1 to control an air flow in the first pneumatic line 132b_1.

The operation part 133a is installed on the upper part of the first valve part 133, and the first valve part 133 has a mechanical structure as an inner structure thereof, wherein the first valve part 133 is open when the operation part 133a moves downwards and is closed when the operation part 133a moves upwards.

According to the first exemplary embodiment, the first valve part 133 has a mechanical structure in which the opening/closing thereof is determined according to the movement of the operation part 133a, but the inventive concept is not limited thereto. That is, an electrically driven valve may be used for the first valve part 133. For example, an electronic solenoid valve may be used as the first valve part 133.

The second valve part 134 is installed on the second pneumatic line 132b_2 to control an air flow in the second pneumatic line 132b_2. As described above, since the second pneumatic line 132b_2 is connected in parallel to the first pneumatic line 132b_1, the second valve part 134 is also connected in parallel to the first valve part 133.

The second valve part 134 is electrically connected to the control unit 140 and operates under control of the control unit 140.

The second valve part 134 has a structure capable of adjusting an open level thereof, and electrically driven valves of various types, such as an electronic solenoid valve, may be used as the second valve part 134 for easy control by the control unit 140. However, the inventive concept is not limited thereto, and, for example, a mechanic valve may be used as the second valve part 134.

The hydraulic power assistance part 135 provides a braking force to the friction working part 131, is of a hydraulic piston type, and includes a working part 135a at one end thereof. To this end, a portion of the hydraulic power assistance part 135 is connected to the fourth pneumatic line 132b_4, and the working part 135a of the hydraulic power assistance part 135 is connected to the friction block 131b to provide a braking force.

According to the first exemplary embodiment, a configuration in which the friction block 131b moves by an operation of the working part 135a of the hydraulic power assistance part 135 is disclosed, but the inventive concept is not limited thereto. That is, the configuration in which the hydraulic power assistance part 135 operates the friction block 131b may be variously modified within the scope.

According to the first exemplary embodiment, a pneumatic pressure of the pneumatic line system 132 provides a braking force to the friction working part 131 after being power-assisted by the hydraulic power assistance part 135, but the inventive concept is not limited thereto. That is, according to the inventive concept, the hydraulic power assistance part 135 may not be interposed between the pneumatic line system 132 and the friction working part 131. In this case, a braking force is provided to the friction block 131b only by the pneumatic pressure of the pneumatic line system 132.

The control unit 140 controls the entire brake system 100. That is, the control unit 140 includes an electrical circuit, an integrated circuit chip, and the like, and controls parts to be controlled by performing computations according to programs for operating the brake system 100, and a detailed control method and operation thereof will be described below.

The control unit 140 is electrically connected to the pedal sensor 113, the charge amount measuring device 123, and the pneumatic pressure sensor 132c, receives measured results therefrom, performs appropriate computations based on an operation program, and properly controls operations of the second valve part 134 and the air compressor 132d.

According to the first exemplary embodiment, the brake system 100 includes the manipulation part 110, the first valve part 133, and the second valve part 134 that are separated from each other, but the inventive concept is not limited thereto. That is, according to the inventive concept, the manipulation part 110, the first valve part 133, and the second valve part 134 may be manufactured as one modular part, and installation and maintenance of the modular part are easy.

As described above, the brake system 100 according to the first embodiment includes the regenerative braking unit 120 and the friction braking unit 130, and has a configuration in which the first valve part 133 and the second valve part 134 are connected in parallel to the pneumatic line system 132 to control the friction braking of the friction braking unit 130, thereby resulting in a simple configuration and stable braking.

Hereinafter, a method of controlling the brake system 100 according to the first exemplary embodiment will be described with reference to FIGS. 2 and 3A to 3C.

FIG. 2 is a flowchart illustrating a method of controlling the brake system 100, according to the first embodiment, and FIGS. 3A to 3C are schematic operational diagrams of the method of controlling the brake system 100, according to the first exemplary embodiment.

FIG. 3A is a schematic diagram when the user does not operate the manipulation part 110, and in this state, the pedal 111 and the valve opening/closing part 112 contact each other, but the valve opening/closing part 112 has not moved downwards due to an elastic force of the second elastic member 112a.

As shown in FIG. 3B, when the user starts pressing the pedal 111 with a foot for braking in operation S110, the pedal 111 rotates clockwise, and the valve opening/closing part 112 is pressed by the pedal 111 and moves downwards. At this time, the pedal sensor 113 detects whether the pedal 111 is pressed and a pressing stroke amount of the pedal 111, and transmits the detection result to the control unit 140.

When the manipulation part 110 starts to operate, the valve opening/closing part 112 is pressed by the pedal 111 and moves downwards, and accordingly, the operation part 133a of the first valve part 133 also moves downwards to thereby open the first valve part 133 in operation S120.

When the first valve part 133 is open, the compressed air in the pneumatic line system 132 moves towards the hydraulic power assistance part 135, and accordingly, an oil pressure acts on the friction block 131b of the friction working part 131 so that the friction block 131b presses and rubs against the brake wheel 131a to achieve a braking work.

At the same time, when the manipulation part 110 starts to operate, the control unit 140 recognizes, by the pedal sensor 113, that the pedal 111 is pressed. Thereafter, the control unit 140 determines in operation S130-1 whether regenerative braking works and controls the second valve part 134 to be open in operation S130-2 when the regenerative braking does not work or to be closed in operation S130-3 when the regenerative braking works. The determination on whether the regenerative braking works is achieved by the charge amount measuring device 123 determining a charge level of the battery unit 122 to thereby determine that the regenerative braking does not work when the charge level of the battery unit 122 is about 80% or above of a full charge state or determine that regenerative braking works when the charge level of the battery unit 122 is less than about 80% of the full charge state. The value of about 80% that is a reference of the determination may vary according to a system type or a design, for example, may be 70%, 75%, 85%, 90%, or 95%.

According to the first exemplary embodiment, the determining of whether the regenerative braking works is achieved by the charge amount measuring device 123 determining a charge level of the battery unit 122, but the inventive concept is not limited thereto. That is, according to the inventive concept, the determination on whether the regenerative braking works may be achieved in various methods. For example, to determine whether the regenerative braking works, a method of measuring a change in a voltage/current flowing through an electric circuit related to the regenerative braking in the brake system 100, a method of measuring a fine load change in the rotating body S according to power generation of the power generation unit 121, or the like may be used.

When the second valve part 134 is open, air in the pneumatic line system 132 additionally moves to the hydraulic power assistance part 135, and accordingly, an oil pressure additionally acts on the friction block 131b so that the friction block 131b further presses the brake wheel 131a to help the braking. In this case, an insufficient braking force in a case where the regenerative braking does not work may be supplemented.

FIG. 3B shows that the second valve part 134 starts to be open when the regenerative braking does not work, and FIG. 3C shows that the first and second valve parts 133 and 134 are maximally open when the regenerative braking does not work.

As shown in FIG. 3C, when the pedal 111 is maximally pressed, a pressing stroke amount is maximum, and the control unit 140 receives the pressing stroke amount of the pedal 111 from the pedal sensor 113 and controls an open level of the second valve part 134 to be maximum.

When the regenerative braking works, the control unit 140 closes the second valve part 134 as described above, and in this case, braking is achieved by a fiction braking force due to the opening of the first valve part 133 and a regenerative braking force.

As described above, in the method of controlling the brake system 100 according to the first exemplary embodiment, friction braking due to the opening of the first valve part 133 is performed from the start of an operation of the manipulation part 110. In addition, a braking force that is insufficient even when the friction braking due to the opening of the first valve part 133 is performed may be supplemented by regenerative braking or by additional friction braking due to the opening of the second valve part 134 when the regenerative braking does not work, thereby realizing stable brake performance.

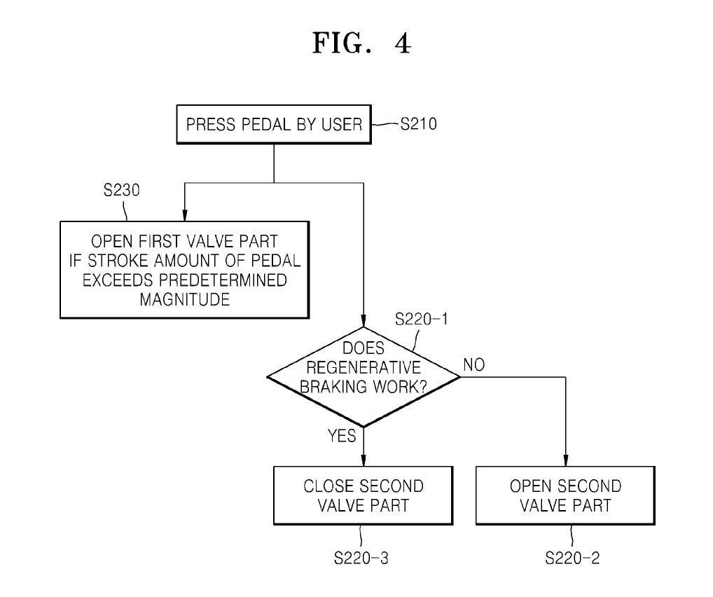

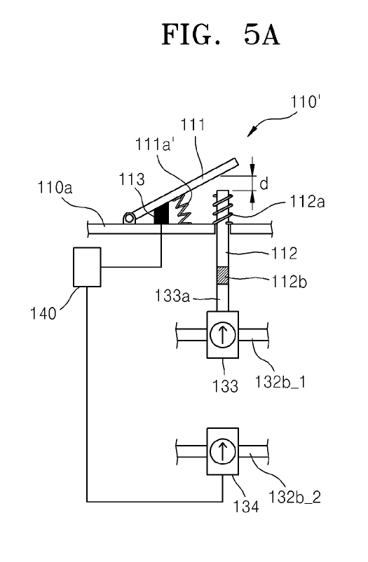

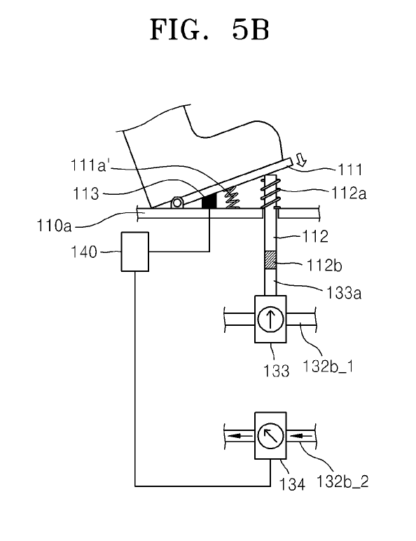

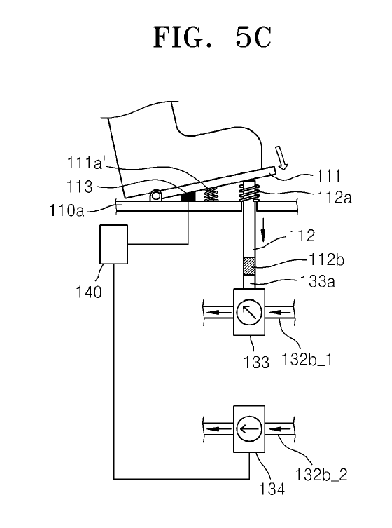

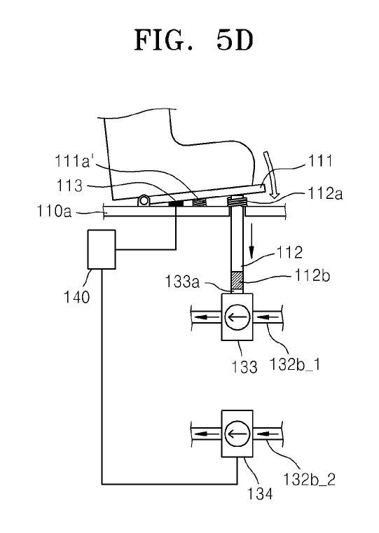

Hereinafter, one modified implementation of the method of controlling the brake system 100 according to the first exemplary embodiment is described with reference to FIGS. 4 and 5A to 5D.

FIG. 4 is a flowchart illustrating a method of controlling a brake system, according to a modified version of the first exemplary embodiment, and FIGS. 5A to 5D are schematic operational diagrams of the method of controlling the brake system, according to the modified version of the first exemplary embodiment.

The brake system according to the modified embodiment has almost the same configuration as the brake system 100 described above, and thus, like reference numerals denote like elements having substantially the same configuration. Thus, repetitive description will be omitted.

An installation configuration of a first elastic member 111a′ of a manipulation part 110′ of the modified embodiment is different from an installation configuration of the first elastic member 111a of the first embodiment.

FIG. 5A is schematic diagram in a state when the pedal 111 is not pressed. As shown in FIG. 5A, the pedal 111 is installed on a frame 110a in a hinge structure to pivot when a user presses the pedal 111 by foot and is elastically supported by a first elastic member 111a′, such as a spring or the like.

The valve opening/closing part 112 has a bar shape and is elastically supported by the second elastic member 112a that may be a spring or the like. In addition, the connection part 112b of the valve opening/closing part 112 is fixedly connected to the operation part 133a of the first valve part 133.

A length of the first elastic member 111a′ is longer than that of the first elastic member 111a described above in reference to FIG. 3A. As a result, when the pedal 111 is not pressed, a predetermined distance d exists between the lower surface of the pedal 111 and an end part of the valve opening/closing part 112. That is, although the user starts pressing the pedal 111, the valve opening/closing part 112 is not pressed until a stroke amount corresponds to the predetermined distance d.

According to this modified exemplary embodiment, the length of the first elastic member 111a′ is adjusted and installed so that the predetermined distance d exists between the lower surface of the pedal 111 and the end part of the valve opening/closing part 112, but the inventive concept is not limited thereto. That is, according to the inventive concept, a method of extending the length of the first elastic member 111a′ and reducing the length of the valve opening/closing part 112 may be used so that the predetermined distance d exists between the lower surface of the pedal 111 and the end part of the valve opening/closing part 112. Alternatively, a method of reducing only the length of the valve opening/closing part 112 may be used so that the predetermined distance d exists between the lower surface of the pedal 111 and the end part of the valve opening/closing part 112.

When the user starts pressing the pedal 111 by foot in operation S210, the pedal 111 rotates clockwise, and the pedal sensor 113 detects whether the pedal 111 is pressed, and transmits the detection result to the control unit 140. Thereafter, the control unit 140 determines in operation S220-1 whether regenerative braking works and controls the second valve part 134 to be open in operation S220-2 when the regenerative braking does not work or to be closed in operation S220-3 when the regenerative braking works. The method of determining whether the regenerative braking works, which has been described above, may be applied to a method of determining whether the regenerative braking works as it is, and thus, a description thereof is omitted.

When the regenerative braking does not work, the second valve part 134 is open, and then, air in the pneumatic line system 132 moves towards the hydraulic power assistance part 135, and accordingly, an oil pressure acts on the friction block 131b so that the friction block 131b presses the brake wheel 131a to achieve a braking work. In this case, initial braking of the brake system according to the modified embodiment is achieved. That is, the initial braking in the modified embodiment, i.e., braking until the lower surface of the pedal 111 contacts the end part of the valve opening/closing part 112 after the pedal 111 is pressed, is achieved by the regenerative braking or friction braking due to the open of the second valve part 134.

When the user further keeps pressing the pedal 111, as shown in FIG. 5B, the lower surface of the pedal 111 and the end part of the valve opening/closing part 112 contact each other so that the first valve part 133 is completely ready to be open. This state is a state where the first valve part 133 is completely ready to be open since a stroke amount of the pedal 111 corresponds to the predetermined distance d.

When the user further keeps pressing the pedal 111 in this state, if an operation of the manipulation part 110′ exceeds a predetermined state (i.e., if a stroke amount of the pedal 111 exceeds the predetermined distance d (referring to FIGS. 5C and 5D)), the valve opening/closing part 112 is pressed by the pedal 111 and moves downwards, and accordingly, the operation part 133a of the first valve part 133 also moves downwards to thereby open the first valve part 133 in operation S230.

When the first valve part 133 is open, compressed air in the first pneumatic line 132b_1 moves towards the hydraulic power assistance part 135, and accordingly, an oil pressure additionally acts on the friction block 131b of the friction working part 131 so that the friction block 131b presses and rubs against the brake wheel 131a to achieve a braking work.

FIG. 5C shows a case where the first valve part 133 starts to be open, and FIG. 5D shows a case where the pedal 111 is maximally pressed and the first and second valve parts 133 and 134 are maximally open.

As described above, in the method of controlling the brake system according to the modified version of the first embodiment, regenerative braking or friction braking due to the opening of the second valve part 134 is performed in the initial braking, and if a pressing amount of the pedal 111 increases, a friction braking force due to the open of the first valve part 133 is added to achieve braking, thereby realizing efficient and stable braking.

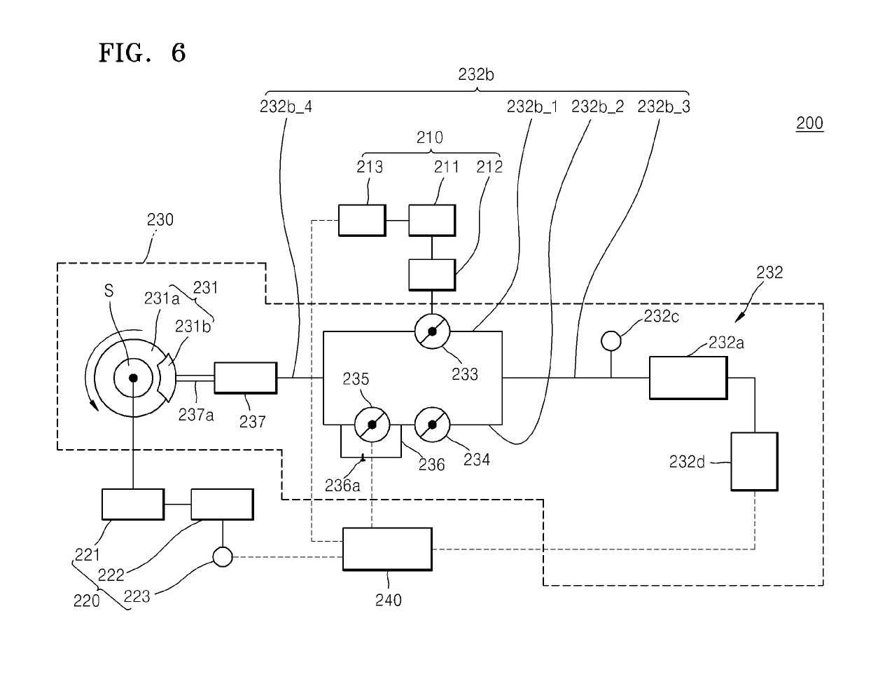

Hereinafter, a brake system 200 according to a second exemplary embodiment is described with reference to FIGS. 6, 7, and 8A to 8C.

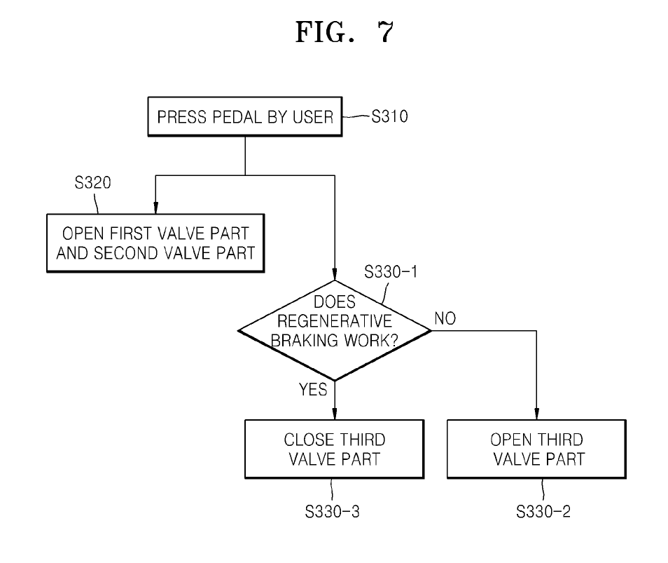

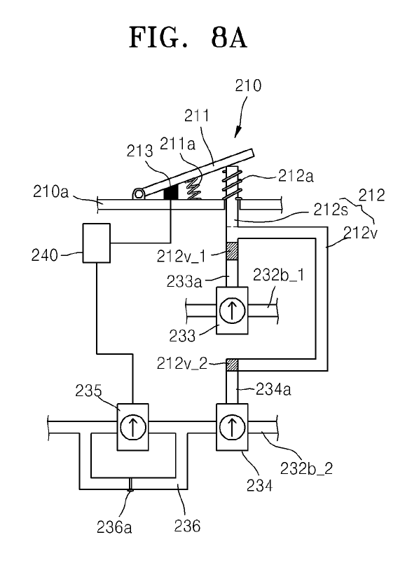

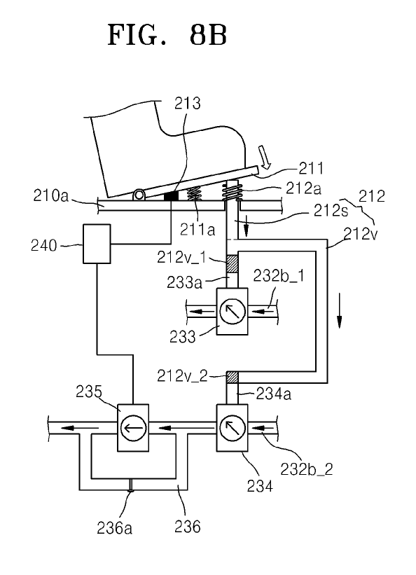

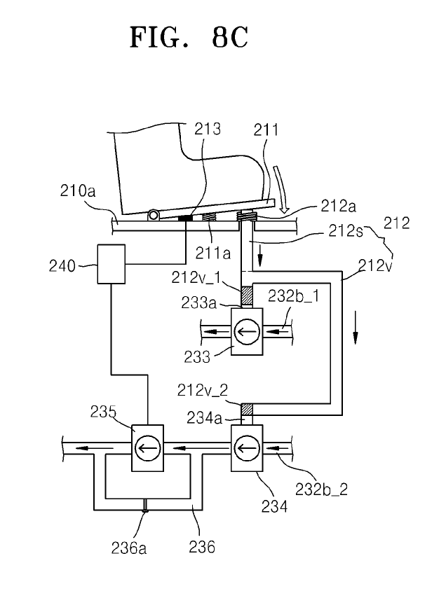

FIG. 6 is a schematic diagram of the brake system 200 according to the second exemplary embodiment, FIG. 7 is a flowchart illustrating a method of controlling the brake system 200, according to the second exemplary embodiment, and FIGS. 8A to 8C are schematic operational diagrams of the method of controlling the brake system 200, according to the second exemplary embodiment.

The brake system 200 according to the second exemplary embodiment includes a manipulation part 210, a regenerative braking unit 220, a friction braking unit 230, and a control unit 240.

The manipulation part 210 includes a pedal 211, a valve opening/closing part 212, and a pedal sensor 213.

A basic configuration of the manipulation part 210 is shown in FIG. 8A. That is, as shown in FIG. 8A, the pedal 211 is installed on a frame 210a in a hinge structure to pivot when a user presses the pedal 211 by foot and is elastically supported by a first elastic member 211a that may be a spring or the like.

The valve opening/closing part 212 includes a first part 212s having a bar shape and a second part 212v connected to the first part 212s and having a bent shape. The first part 212s is elastically supported by a second elastic member 212a, that may be a spring or the like, with respect to the frame 210a. In addition, connection parts 212v_1 and 212v_2 of the second part 212v of the valve opening/closing part 212 are fixedly connected to an operation part 233a of a first valve part 233 and an operation part 234a of a second valve part 234, respectively.

According to the second exemplary embodiment, the second part 212v has a bent shape, but the inventive concept is not limited thereto. That is, the second part 212v may not have a bent shape. Since the second part 212v functions to deliver a motion of the first part 212s to the operation part 233a of the first valve part 233 and the operation part 234a of the second valve part 234, there is no other special limitation only if the second part 212v performs this function.

When the user presses the pedal 211, the valve opening/closing part 212 moves downwards by the pedal 211, and accordingly, the operation part 233a of the first valve part 233 and the operation part 234a of the second valve part 234 also move downwards, thereby opening the first valve part 233 and the second valve part 234.

When the user releases the pressing on the pedal 211, the pedal 211 returns to its original location by the first elastic member 211a, and the operation part 233a of the first valve part 233 and the operation part 234a of the second valve part 234 also move upwards by the second elastic member 212a, thereby closing the first valve part 233 and the second valve part 234.

According to the second exemplary embodiment, the pedal 211, the valve opening/closing part 212, the first valve part 233, and the second valve part 234 are mechanically connected to each other, and are configured to open the first valve part 233 and the second valve part 234 by delivering a mechanical force to press the pedal 211 to the first valve part 233 and the second valve part 234 via the valve opening/closing part 212, but the inventive concept is not limited thereto. That is, the valve opening/closing part 212 may be electronically configured and electrically connected to the pedal 211 to open or close the first valve part 233 and the second valve part 234 by pressing the pedal 211.

The pedal sensor 213 measures a motion of the pedal 211 and includes a pedal effort sensor for measuring a load by using a load cell or the like. The pedal sensor 213 is electrically connected to the control unit 240, and the control unit 240 may determine whether the pedal 211 is pressed and a pressing stroke amount of the pedal 211 by using a measured load.

According to the second exemplary embodiment, the pedal effort sensor is used as the pedal sensor 213, but the inventive concept is not limited thereto. That is, the pedal sensor 213 may include a rotation angle measuring sensor for measuring a rotation angle of the pedal 211, a distance sensor for measuring a movement amount of the pedal 211, and the like.

According to the second exemplary embodiment, the manipulation part 210 is configured to include the pedal 211 pressed by foot, but the inventive concept is not limited thereto. That is, a structure and a method for configuring the manipulation part 210 are not specially limited. For example, the manipulation part 210 may be a lever that is pulled by hand.

The regenerative braking unit 220 brakes a rotational motion of a rotating body S according to a regenerative braking scheme and includes a power generation unit 221, a battery unit 222, and a charge amount measuring device 223.

The power generation unit 221 includes at least one power generator and converts a rotational motion of the rotating body S to electric energy. The number of power generators included in the power generation unit 221 is not specially limited.

The battery unit 222 includes at least one battery charged by receiving power from the power generation unit 221. The number of batteries included in the power generation unit 221 is not specially limited. For example, only one battery may be used or two or more of batteries may be connected in series or parallel to each other.

The charge amount measuring device 223 measures a charge level of the battery unit 222, and a well-known charge sensor, a well-known charge amount measuring circuit, or a well-known circuit for measuring an internal voltage of the battery unit 222 may be used as the charge amount measuring device 223.

The charge amount measuring device 223 is electrically connected to the control unit 240, and thus, the control unit 240 may measure a charge level of the battery unit 222 by using a value transmitted from the charge amount measuring device 223.

The friction braking unit 230 brakes a rotational motion of the rotating body S according to a friction braking scheme.

The friction braking unit 230 includes a friction working part 231, a pneumatic line system 232, a first valve part 233, a second valve part 234, a third valve part 235, a bypass pipeline 236, and a hydraulic power assistance part 237.

The friction working part 231 includes a brake wheel 231a rotating together with the rotating body S and a friction block 231b for braking a rotational motion of the rotating body S by rubbing against the brake wheel 231a.

The pneumatic line system 232 includes at least one storage tank 232a for storing compressed air, a pneumatic line 232b connected to the storage tank 232a, a pneumatic pressure sensor 232c for measuring a pneumatic pressure of the pneumatic line 232b, and an air compressor 232d.

The pneumatic line 232b includes a first pneumatic line 232b_1, a second pneumatic line 232b_2, a third pneumatic line 232b_3, and a fourth pneumatic line 232b_4.

The first valve part 233 is installed on the first pneumatic line 232b_1.

The second pneumatic line 232b_2 is connected in parallel to the first pneumatic line 232b_1, and the second valve part 134, the third valve part 235, and the bypass pipeline 236 are installed on the second pneumatic line 232b_2.

The third pneumatic line 232b_3 is connected to the storage tank 232a, and the fourth pneumatic line 232b_4 is connected to the hydraulic power assistance part 237.

The pneumatic pressure sensor 232c is electrically connected to the control unit 240 and transmits a measured pneumatic pressure to the control unit 240 in real-time. If the measured pneumatic pressure is less than a reference value, the control unit 240 drives the air compressor 232d to supply compressed air to the storage tank 232a so that a pneumatic pressure within a predetermined range is maintained in the pneumatic line 232b.

The first valve part 233 is installed on the first pneumatic line 232b_1 to control an air flow in the first pneumatic line 232b_1.

The operation part 233a is installed on the upper part of the first valve part 233, and the first valve part 233 has a mechanical structure as an inner structure thereof, wherein the first valve part 233 is open when the operation part 233a moves downwards and is closed when the operation part 233a moves upwards.

According to the second exemplary embodiment, the first valve part 233 has a mechanical structure in which opening/closing thereof is determined according to the movement of the operation part 233a, but the inventive concept is not limited thereto. That is, an electrically driven valve may be used as the first valve part 233. For example, an electronic solenoid valve may be used as the first valve part 233.

The second valve part 234 is installed on the second pneumatic line 232b_2 to control an air flow in the second pneumatic line 232b_2. As described above, since the second pneumatic line 232b_2 is connected in parallel to the first pneumatic line 232b_1, the second valve part 234 is also connected in parallel to the first valve part 233.

The operation part 234a is installed on the upper part of the second valve part 234, and the second valve part 234 has a mechanical structure as an inner structure thereof. The second valve part 234 is open when the operation part 234a moves downwards and is closed when the operation part 234a moves upwards.

According to the second exemplary embodiment, the second valve part 234 has a mechanical structure in which opening/closing thereof is determined according to the movement of the operation part 234a, but the inventive concept is not limited thereto. That is, an electrically driven valve may be used as the second valve part 234. For example, an electronic solenoid valve may be used for the second valve part 234.

The third valve part 235 is electrically connected to the control unit 240 and operates under control of the control unit 240.

The third valve part 235 may have an on/off structure that allows a simple change to an open state or a closed state. However, the third valve part 235 is not limited thereto and may have a structure that allows adjusting an open level thereof according to a control signal, instead of the on/off structure.

Electrically driven valves of various types, such as an electronic solenoid valve, may be used as the third valve part 235 for easy control by the control unit 240. However, the inventive concept is not limited thereto. That is, the third valve part 235 is not limited to this structure. For example, a mechanical valve may be used as the third valve part 235.

The bypass pipeline 236 is installed to bypass the third valve part 235. The bypass pipeline 236 is a facility for emergency braking when the third valve part 235 is broken down or does not normally operate.

An emergency valve 236a is installed on the bypass pipeline 236. The emergency valve 236a is normally closed to close the bypass pipeline 236, but the user may open the emergency valve 236a in an emergency state to force a fluid to flow through the bypass pipeline 236. That is, the user may open the bypass pipeline 236 by pulling the emergency valve 236a in an emergency state.

According to the second exemplary embodiment, the user may directly open the bypass pipeline 236 by manually pulling the emergency valve 236a in an emergency state, but the inventive concept is not limited thereto. That is, according to the inventive concept, the control unit 240 may automatically open the emergency valve 236a according to an operating program in an emergency state to open the bypass pipeline 236.

The hydraulic power assistance part 237 provides a braking force to the friction working part 231, is of a hydraulic piston type, and includes a working part 237a at one end thereof. To this end, a portion of the hydraulic power assistance part 237 is connected to the fourth pneumatic line 232b_4, and the working part 237a of the hydraulic power assistance part 237 is connected to the friction block 231b to provide a braking force.

According to the second exemplary embodiment, a configuration in which the friction block 231b moves by an operation of the working part 237a of the hydraulic power assistance part 237 is disclosed, but the inventive concept is not limited thereto. That is, the configuration in which the hydraulic power assistance part 237 operates the friction block 231b may be variously modified within the scope of the inventive concept.

According to the second exemplary embodiment, a pneumatic pressure of the pneumatic line system 232 provides a braking force to the friction working part 231 after being power-assisted by the hydraulic power assistance part 237, but the inventive concept is not limited thereto. That is, according to the inventive concept, the hydraulic power assistance part 237 may not be interposed between the pneumatic line system 232 and the friction working part 231. In this case, a braking force is provided to the friction block 231b only by the pneumatic pressure of the pneumatic line system 232.

The control unit 240 controls the entire brake system 200. That is, the control unit 240 includes an electrical circuit, an integrated circuit chip, and the like and controls parts to be controlled by performing computations according to programs for operating the brake system 200, and a detailed control method and operation thereof will be described below.

The control unit 240 is electrically connected to the pedal sensor 213, the charge amount measuring device 223, and the pneumatic pressure sensor 232c, receives measured results therefrom, performs appropriate computations based on an operation program, and properly controls operations of the third valve part 235 and the air compressor 232d.

According to the second exemplary embodiment, the brake system 200 includes the manipulation part 210, the first valve part 233, the second valve part 234, and the third valve part 235 that are separated from each other, but the inventive concept is not limited thereto. That is, according to the inventive concept, the manipulation part 210, the first valve part 233, the second valve part 234, and the third valve part 235 may be manufactured as one modular part of which installation and maintenance are easy.

As described above, the brake system 200 according to the second exemplary embodiment includes the regenerative braking unit 220 and the friction braking unit 230, and has a configuration in which the first valve part 233 and the second valve part 234 are connected in parallel to and the second valve part 234 and the third valve part 235 are connected in series to the pneumatic line system 232 to control the friction braking of the friction braking unit 230, thereby resulting in a simple configuration and stable braking.

Hereinafter, a method of controlling the brake system 200 according to the second exemplary embodiment will be described with reference to FIGS. 7 and 8A to 8C.

FIG. 8A is a schematic diagram of a case when the user does not operate the manipulation part 210. In this state, the pedal 211 and an end part of the valve opening/closing part 212 contact each other, but the valve opening/closing part 212 has not moved downwards due to an elastic force of the second elastic member 212a. In this state, the first valve part 233, the second valve part 234, and the third valve part 235 are closed.

As shown in FIG. 8B, when the user starts pressing the pedal 211 by foot for braking in operation S310, the pedal 311 rotates clockwise, and the valve opening/closing part 212 is pressed by the pedal 211 and moves downwards. At this time, the pedal sensor 213 detects whether the pedal 211 is pressed and a pressing stroke amount of the pedal 211, and transmits the detection result to the control unit 240.

When the manipulation part 210 starts to operate, the valve opening/closing part 212 is pressed by the pedal 211 and moves downwards, and accordingly, the operation part 233a of the first valve part 233 and the operation part 234a of the second valve part 234 also move downwards by a motion of the second part 212v of the valve opening/closing part 212 to thereby open the first valve part 233 and the second valve part 234 in operation S320.

When the first valve part 233 is open, the compressed air in the pneumatic line system 232 moves towards the hydraulic power assistance part 237 through the first pneumatic line 232b_1, and accordingly, an oil pressure acts on the friction block 231b of the friction working part 231 so that the friction block 231b presses and rubs against the brake wheel 231a to achieve braking. However, even though the second valve part 234 is open, if the third valve part 235 is not open, the compressed air in the pneumatic line system 232 does not move towards the hydraulic power assistance part 237 through the second pneumatic line 232b_2. Thus, the movement of the compressed air through the second pneumatic line 232b_2 in a pressed state of the pedal 211 is determined by open/close of the third valve part 235.

At the same time, when the manipulation part 210 starts to operate, the control unit 240 recognizes via the pedal sensor 213 that the pedal 211 is pressed. Thereafter, the control unit 240 determines in operation S330-1 whether regenerative braking works, and controls the third valve part 235 to be open in operation S330-2 when the regenerative braking does not work or to be closed in operation S330-3 when the regenerative braking works. The determining of whether the regenerative braking works is achieved by the charge amount measuring device 223 determining a charge level of the battery unit 222 to thereby determine that the regenerative braking does not work when the charge level of the battery unit 222 is about 80% or above of a full charge state or determine that regenerative braking works when the charge level of the battery unit 222 is less than about 80% of the full charge state. The value of about 80% that is a reference of the determination may vary according to a system type or a design, for example, may be 70%, 75%, 85%, 90%, or 95%.

According to the second exemplary embodiment, the determining of whether the regenerative braking works is achieved by the charge amount measuring device 223 determining a charge level of the battery unit 222, but the inventive concept is not limited thereto. That is, according to the inventive concept, the determining of whether the regenerative braking works may be achieved in various methods. For example, to determine whether the regenerative braking works, a method of measuring a change in a voltage/current flowing through an electric circuit related to the regenerative braking in the brake system 200, a method of measuring a fine load change in the rotating body S according to power generation of the power generation unit 221, or the like may be used.

When the third valve part 235 is open in a pressed state of the pedal 211, the compressed air in the pneumatic line system 232 additionally moves to the hydraulic power assistance part 237 through the second pneumatic line 232b_2 as described above, and accordingly, an oil pressure additionally acts on the friction block 231b so that the friction block 231b further presses the brake wheel 231a to help the braking. In this case, an insufficient braking force in a case where the regenerative braking does not work may be supplemented.

FIG. 8B shows that the first valve part 233 and the second valve part 234 start to be open in an open state of the third valve part 235 when the regenerative braking does not work, and FIG. 8C shows that the first and second valve parts 233 and 234 are maximally open in an open state of the third valve part 235 when the regenerative braking does not work in a pressed state of the pedal 211.

When the regenerative braking works, the control unit 240 closes the third valve part 235 as described above, and in this case, braking is achieved by a fiction braking force due to the opening of the first valve part 233 and a regenerative braking force.

As described above, in the method of controlling the brake system 200 according to the second exemplary embodiment, friction braking due to the open of the first valve part 233 is performed from the start of an operation of the manipulation part 210. In addition, a braking force that is insufficient even when the friction braking due to the open of the first valve part 133 is performed may be supplemented by a regenerative braking force or by additional friction braking due to the opening of the second valve part 234 in an open state of the third valve part 235 when the regenerative braking does not work, thereby realizing stable brake performance.

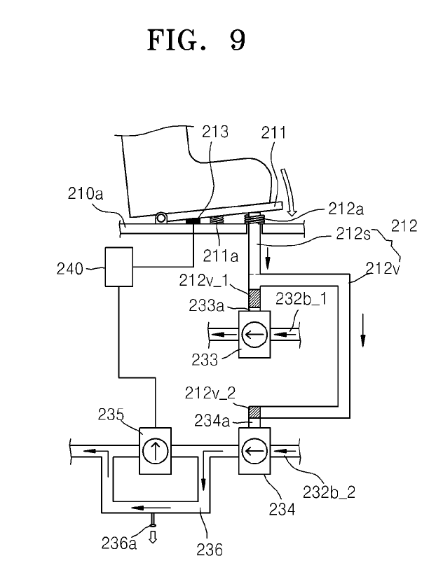

According to the second exemplary embodiment, when the third valve part 235 or the control unit 240 breaks down, even though regenerative braking does not work, the third valve part 235 may be in a closed state. In this case, a braking force is insufficient, and in this emergency state, the user may directly open the emergency valve 236a as shown in FIG. 9.

FIG. 9 is a schematic operational diagram of a case of opening the emergency valve 236a in an emergency state where the third valve part 235 of the brake system 200 according to the second exemplary embodiment does not operate normally.

As shown in FIG. 9, when the user directly pulls the emergency valve 236a to open the emergency valve 236a, the compressed air in the pneumatic line system 232 moves to the hydraulic power assistance part 237 by sequentially passing through the second valve part 234 and the bypass pipeline 236, and accordingly, an oil pressure additionally acts on the friction block 231b so that the friction block 231b further presses the brake wheel 231a to help the braking.

According to an exemplary embodiment, a brake system with stable brake performance and a method of controlling the same may be implemented.

While the inventive concept has been particularly shown and described with reference to exemplary embodiments thereof, it will be understood by one of ordinary skill in the art that various changes in form and details may be made therein without departing from the spirit and scope of the inventive concept as defined by the following claims.

What is claimed is:

1. A brake system comprising:
a manipulation part configured to provide a brake input;
a regenerative braking unit configured to perform regenerative braking;
a friction braking unit configured to perform friction braking; and
a control unit configured to control the brake system,
wherein the friction braking unit comprises:
a friction working part configured to brake a rotating body by friction;
a pneumatic line system configured to operate the friction working part;
a first valve part connected to the pneumatic line system; and
a second valve part connected to the pneumatic line system and connected in parallel to the first valve part.

2. The brake system of claim 1, wherein the manipulation part comprises:
a pedal; and
a valve opening/closing part connected to the pedal to open or close the first valve part.

3. The brake system of claim 2, further comprising a pedal sensor configured to measure a motion of the pedal.

4. The brake system of claim 1, wherein the regenerative braking unit comprises:
a power generation unit configured to convert a rotational motion of the rotating body into electric energy; and
a battery unit charged by receiving electricity from the power generation unit.

5. The brake system of claim 4, further comprising a charge amount measuring device configured to measure a charge level of the battery unit.

6. The brake system of claim 1, wherein the pneumatic line system comprises:
at least one storage tank configured to store compressed air; and
pneumatic lines connected to the storage tank.

7. The brake system of claim 1, wherein the pneumatic line system is connected to a hydraulic power assistance part which provides a braking force to the friction working part.

8. The brake system of claim 1, further comprising a third valve part connected in series to the second valve part.

9. The brake system of claim 8, further comprising:
a bypass pipeline which bypasses the third valve part; and
an emergency valve installed on the bypass pipeline.

10. A method of controlling a brake system which performs regenerative braking and friction braking to brake a rotating body and comprises a first valve part connected to a pneumatic line system for the friction braking and a second valve part connected in parallel to the first valve part, the method comprising:
operating a manipulation part;
opening the first valve part in response to the operating the manipulation part; and
determining whether the regenerative braking works in response to the operating the manipulation part, and opening the second valve part if the regenerative braking does not work.

11. The method of claim 10, wherein the regenerative braking comprises:
a power generating operation of converting a rotational motion of the rotating body into electric energy; and
a charging operation of charging a battery unit with electricity generated in the power generating operation.

12. The method of claim 11, wherein the determining whether the regenerative braking works comprises determining whether the regenerative braking works by measuring a charge level of the battery unit in the charging operation.

13. A method of controlling a brake system which performs regenerative braking and friction braking to brake a rotating body and comprises a first valve part connected to a pneumatic line system for the friction braking and a second valve part connected in parallel to the first valve part, the method comprising:
operating a manipulation part;
determining whether the regenerative braking works in response to the operating the manipulation part, and opening the second valve part if the regenerative braking does not work; and
opening the first valve part if an operation level of the manipulation part exceeds a predetermined state.

14. The method of claim 13, wherein the operating the manipulation part is performed by pressing a pedal, and
wherein if a stroke amount of the pedal exceeds a predetermined magnitude, it is considered that an operation level of the manipulation part exceeds the predetermined state, and the first valve part is open.

15. The method of claim 13, wherein the regenerative braking comprises:
a power generating operation of converting a rotational motion of the rotating body into electric energy; and
a charging operation of charging a battery unit with electricity generated in the power generating operation.

16. The method of claim 15, wherein the determining whether the regenerative braking works comprises determining whether the regenerative braking works by measuring a charge level of the battery unit in the charging operation.

17. A method of controlling a brake system which performs regenerative braking and friction braking to brake a rotating body and comprises a first valve part connected to a pneumatic line system for the friction braking, a second valve part connected in parallel to the first valve part, and a third valve part connected in series to the second valve part, the method comprising:
operating a manipulation part;
opening the first and second valve parts in response to the operating the manipulation part; and
determining whether the regenerative braking works in response to the operating the manipulation part, and opening the third valve part if the regenerative braking does not work.

18. The method of claim 17, wherein the regenerative braking comprises:
a power generating operation of converting a rotational motion of the rotating body into electric energy; and
a charging operation of charging a battery unit with electricity generated in the power generating operation.

19. The method of claim 18, wherein the determining whether the regenerative braking works comprises determining whether the regenerative braking works by measuring a charge level of the battery unit in the charging operation.
